(19) United States
(12) Patent Application Publication
(10) Pub. No.: US 2014/0116615 A1
(43) Pub. Date: May 1, 2014

(54) Adhesive Composition, Bonding Method Using Adhesive Composition, and Separation Method After Bonding

(71) Applicant: Central Glass Company, Limited, Ube-shi (JP)

(72) Inventors: Tsuyoshi OGAWA, Iruma-gun (JP); Kiminori SATO, Kawagoe-shi (JP); Hiroki UOYAMA, Iruma-gun (JP); Kazuhiro YAMANAKA, Tokyo (JP)

(73) Assignee: Central Glass Company, Limited, Ube-shi (JP)

(21) Appl. No.: 14/062,051

(22) Filed: Oct. 24, 2013

(30) Foreign Application Priority Data
Oct. 25, 2012 (JP) 2012-235238
Oct. 25, 2012 (JP) 2012-235239
Oct. 9, 2013 (JP) 2013-211492
Oct. 9, 2013 (JP) 2013-211493

(51) Int. Cl. C09J 133/04; B32B 38/00; B32B 38/10; B32B 37/12

(52) U.S. Cl. CPC C09J 133/04; B32B 37/12; B32B 38/0008; B32B 38/10
USPC 156/275.5; 156/329; 156/709; 521/113

(57) ABSTRACT

An adhesive composition according to the present invention contains a polymerizable group-containing siloxane compound, a polymerization initiator and an ultraviolet-absorbing blowing agent. This adhesive composition enables quick bonding of substrates etc. by light irradiation or by heating such that the bonded substrates can secure adhesion and heat resistance to withstand grinding etc. and, when no longer needed to be bonded, can be easily separated from each other by ultraviolet light irradiation and is thus suitable for use as an adhesive composition for manufacturing of semiconductor devices (particularly for manufacturing of semiconductor devices with through-silicon vias).

### FIELD OF THE INVENTION

The present invention relates to an adhesive composition, a method of bonding using the adhesive composition and a method of separation after the bonding. More specifically, the present invention relates to an adhesive composition for manufacturing of a semiconductor device with an integrated circuit (hereinafter sometimes abbreviated as “IC”) pattern, a method of bonding using the adhesive composition and a method of separation after the bonding and, in particular, to an adhesive composition suitable for a three-dimensional packaging technology in which semiconductor chips are stacked in a thickness direction for high integration of a semiconductor device, a method of bonding using the adhesive composition and a method of separation after the bonding. The present invention particularly preferably relates to, in manufacturing of a semiconductor device in which stacked semiconductor chips are electrically connected to each other by through-silicon vias (hereinafter sometimes abbreviated as “TSV”), an adhesive composition for bonding a silicon substrate on which the semiconductor chips are mounted to a glass substrate such that the glass substrate supports the silicon substrate during grinding of the silicon substrate, a method of bonding using the adhesive composition and a method of separation after the bonding.

### BACKGROUND OF THE INVENTION

It has been attempted to provide semiconductor devices with high-performance characteristics such as small size, high speed and multiple functions by fine processing of IC patterns. However, concerns are rising about the technical limit of fine processing of IC patterns. Attentions are thus being given to three-dimensional packaging technologies in which semiconductor chips are three-dimensionally packaged by stacking two-dimensional arrays of semiconductor chips in thickness directions so as to attain high integration of semiconductor devices without fine processing of IC patterns. For example, Non-Patent Document 1 reports a trend in research and development of TSV techniques for three-dimensional large scale integration (hereinafter sometimes abbreviated as “LSI”) packaging.

A three-dimensional packaging technology in which a plurality of semiconductor chips such as high-integration semiconductor devices (e.g. LSI semiconductor devices) are electrically connected by metal wire bonding and thereby packaged as one semiconductor device, called System in Package (hereinafter sometimes abbreviated as “SiP”), has been put into practical use. In this packaging technology, however, it is necessary to secure a space for wire bonding outside the semiconductor chips in order to perform the three-dimensional packaging of the semiconductor chips by SiP. The necessity for such a space is disadvantageous to achieve downsizing of the semiconductor device. Further, a three-dimensional packaging technology in which through-silicon vias (TSV) are formed to vertically pass through semiconductor chips has been proposed as a technique to provide a semiconductor device with a higher integration density without the necessity to secure a space for wire bonding outside semiconductor chips as mentioned above.

The three-dimensional packaging technology using TSV involves a substrate processing process for the formation of TSV in a semiconductor device with stacked semiconductor chips, including, for example, a step of forming hole grooves in silicon substrates on which IC patterns have been formed, a step of grinding and thinning back surfaces of the silicon substrates such that the hole grooves pass through the silicon substrates as through holes, and then, a step of laminating the silicon substrates with the through holes together into the semiconductor device. After that, the TSV are formed in the through holes.

In the step of forming the through holes in the silicon substrate by grinding and thinning the silicon substrate, it is necessary to conduct the grinding of the silicon substrate in the state where the silicon substrate is bonded to a support member, called support substrate, by an adhesive. In general, an easily-available, low-cost glass substrate is used as the support substrate. The three-dimensional packaging of the semiconductor chips is completed by, after the grinding and thinning the back surfaces of the silicon substrates, separating the silicon substrates from the support substrates, laminating the silicon substrates together and forming the TSV in the respective through holes. There is thus obtained the semiconductor device in which the semiconductor chips with IC patterns are stacked.

Herein, the adhesive used in the above-mentioned through hole forming step is required to ensure good bonding between the silicon substrate and the support substrate, show heat resistance and has the feature that, when the silicon substrate is separated from the support substrate after processing the hole grooves into the through holes by grinding the silicon substrate, a residue of the adhesive does not remain on the silicon substrate and, even if remains, can be easily removed from the silicon substrate. It is further desirable that the separation of the silicon substrate and the support substrate is easy.

Patent Documents 1 to 4 discloses adhesives for TSV formation.

For example, Patent Document 1 discloses a bonding material (as an adhesive) in which a specific thermoplastic composition is dispersed or dissolved in a solvent and uses of the bonding material for bonding of an active wafer to a carrier wafer or substrate and for protection of the active wafer or an active part of the active wafer during processing or handling of the active wafer after the bonding. This bonding material is formed into a bonding layer such that the bonding layer shows chemical resistance as well as heat resistance and can be softened to cause separation by sliding of the wafer at an appropriate stage during manufacturing process. The two bonded substrates are thus separated (peeled) from each other by applying a mechanical force while keeping the bonding material softened at a high temperature. A residue of the bonding material is finally removed from the silicon substrate by washing with a solvent.

Patent Document 2 discloses an adhesive composition that includes, as a main component, a polymer obtained by copolymerization of a monomer composition containing a maleimide-containing monomer, together with a thermal polymerization inhibitor. When two substrates are bonded by this adhesive composition, the bonded substrates are separated from each other simultaneously with the dissolution of the adhesive composition by immersing the bonded substrates in an organic solvent.

Patent Document 3 discloses a method and apparatus for, after mounting a device wafer to a carrier substrate, separating the mounted device wafer from the carrier substrate. In this technique, a silicon substrate is mounted as the wafer by applying an adhesive only to an outer peripheral region of the silicon substrate and supporting an inner region of the silicon substrate with the use of a non-adhesive resin such that no adhesive residue occurs on the inner region of the silicon substrate.

Patent Document 4 discloses, as an adhesive that allows not only strong adhesion but also easy separation and shows high heat resistance, an adhesive composition including a photocurable adhesive containing a polymerizable polymer and a photopolymerization initiator as an adhesive component and a tetrazole compound or a salt thereof, and an adhesive tape using the adhesive composition. In this adhesive tape, a gas (nitrogen) is generated from the tetrazole compound or salt thereof by light irradiation so as to cause surface unevenness by blowing in the soft adhesive component and thereby exert separation stress. Under such separation stress, the adhesive tape is separated from the adherend part by reduction of the bonding area between the adhesive tape and the adherend part.

### PRIOR ART DOCUMENTS

Patent Document 1: Japanese Laid-Open Patent Publication (Translation of International Application) No. 2010-531385
Patent Document 2: Japanese Laid-Open Patent Publication No. 2010-24435
Patent Document 3: Japanese Laid-Open Patent Publication No. 2012-4522
Patent Document 4: Japanese Laid-Open Patent Publication No. 2012-67317
Non-Patent Document 1: Koji Yoshinaga et al., Science & Technology Trends, April 2010, p. 23-34
Non-Patent Document 2: J. Strating et al., Tetrahedron Letters, No. 3, 1969, p. 125-p. 128
Non-Patent Document 3: Hidemitu Uno et al., Tetrahedron Letters, 46, 2005, p. 1981-1983
Non-Patent Document 4: Hiroko Yamada et al., Chem. Eur. J., 2005, 11, p. 6212-6220

### SUMMARY OF THE INVENTION

In manufacturing of semiconductor devices, particularly formation of through-silicon vias (TSV), silicon substrates and support substrates are bonded together by adhesives and separated from each other after predetermined processing operations. If there occur adhesive residues on the silicon substrates, the adhesive residues need to be removed from the silicon substrates. It is thus required that the adhesives allow quick bonding, attain good adhesion and heat resistance to withstand mechanical processing operations such as substrate grinding after the bonding, and then, allow easy separation after the predetermined processing operations.

It is an object of the present invention to provide an adhesive composition satisfying the above requirements, a method of boding using the adhesive composition and a method of separation after the bonding.

Namely, the present invention includes the following aspects 1 to 14.

[Inventive Aspect 1]

An adhesive composition comprising a polymerizable group-containing siloxane compound, a polymerization initiator and an ultraviolet-absorbing blowing agent.

[Inventive Aspect 2]

The adhesive composition according to Inventive Aspect 1, wherein the polymerizable group-containing siloxane compound is an alkoxysilane hydrolysis condensate with a photopolymerizable group.

[Inventive Aspect 3]

The adhesive composition according to Inventive Aspect 2, wherein the photopolymerizable group includes at least one kind selected from the group consisting of acryloyl group, methacryloyl group and vinyl group.

[Inventive Aspect 4]

The adhesive composition according to Inventive Aspect 2 or 3, wherein the polymerization initiator is a photo radical polymerization initiator.

[Inventive Aspect 5]

The adhesive composition according to Inventive Aspect 1, wherein the polymerizable group-containing siloxane compound is a cage-like silsesquioxane with a polymerizable group.

[Inventive Aspect 6]

The adhesive composition according to Inventive Aspect 5, wherein the polymerizable group includes at least one kind selected from the group consisting of acryloyl group, methacryloyl group and vinyl group.

[Inventive Aspect 7]

The adhesive composition according to Inventive Aspect 5 or 6, wherein the polymerization initiator is either a photo radical polymerization initiator or a thermal radical polymerization initiator.

[Inventive Aspect 8]

The adhesive composition according to any one of Inventive Aspects 1 to 7, wherein the ultraviolet-absorbing blowing agent is either a diketone compound or a diazonium salt.

[Inventive Aspect 9]

A method for bonding substrates, comprising:

applying the adhesive composition according to any one of Inventive Aspects 1 to 8 to between the substrates; and

curing the adhesive composition.

[Inventive Aspect 10]

The method for bonding according to Inventive Aspect 9, wherein a silicon substrate and a glass substrate are bonded together as the substrates.

[Inventive Aspect 11]

The method for bonding according to Inventive Aspect 9 or 10, wherein the substrates are bonded to together by irradiating the adhesive composition with a light having a wavelength of 300 to 900 nm for a sufficient time to cure the adhesive composition.

[Inventive Aspect 12]

The method for bonding according to Inventive Aspect 9 or 10, wherein the substrates are bonded together by heating the adhesive composition at 60 to 200° C.

[Inventive Aspect 13]

The method for bonding according to any one of Inventive Aspects 9 to 12, further comprising: applying an alkoxysilane hydrolysis condensate with a photopolymerizable group to a bonding surface of the glass substrate.

[Inventive Aspect 14]

A method for separating a glass substrate and a silicon substrate that have been bonded together by the adhesive composition according to any one of Inventive Aspects 1 to 8, comprising:

allowing the ultraviolet-absorbing blowing agent to cause blowing by irradiating the adhesive composition with a light having a wavelength of 200 to 420 nm.

The adhesive composition according to the present invention enables quick bonding of substrates etc. by curing the adhesive composition under light irradiation or heating. For example, it is feasible to bond a glass substrate and a silicon substrate together by applying the adhesive composition to between the glass and silicon substrates and curing the adhesive composition with irradiation of a light from the glass substrate side. The bonding objects bonded together by the adhesive composition according to the present invention can be separated from each other under ultraviolet light irradiation as the ultraviolet-absorbing blowing agent makes a chemical change, generates a gas and thereby causes blowing under the action of ultraviolet light. In the case where the silicon substrate and the glass substrate are bonded together as the bonding objects, for example, it is feasible to separate (peel) the glass and silicon substrates from each other with irradiation of an ultraviolet light such that any adhesive residue cannot be at least visually seen, i.e., does not remain on the silicon substrate after the separation.

### BRIEF DESCRIPTION OF DRAWINGS

FIGS. 1(A), 1(B) and 1(C) are schematic views showing steps of bonding and separation of a glass substrate and a silicon substrate.

### DESCRIPTION OF EMBODIMENTS

The adhesive composition according to the present invention, the method of bonding using the adhesive and the method of separation after the bonding will be described in detail below.

The adhesive composition according to the present invention enables quick bonding of substrates etc. by light irradiation or by heating such that the bonded substrates can secure adhesion and heat resistance to withstand grinding etc. and, when no longer needed to be bonded, can be easily separated from each other by ultraviolet light irradiation. The adhesive composition according to the present invention is thus suitable for manufacturing of semiconductor devices. In other words, the present invention is preferably embodied as an adhesive composition for manufacturing of semiconductor devices, a method of bonding and a method of separation after the bonding, particularly preferably an adhesive composition for manufacturing of semiconductor devices with through-silicon vias (TSV), a method of bonding and a method of separation after the bonding.

In the present invention, the term “ultraviolet-absorbing blowing agent” refers to a blowing agent capable of, when irradiated with and absorbing a near-ultraviolet light having a wavelength of 200 to 380 nm or a light having a wavelength of 380 to 400 nm that is close to the ultraviolet range, causing blowing by gas generation under the action of the absorbed light. Hereinafter, a light of 200 to 420 nm wavelength is referred to as an ultraviolet light unless otherwise specified. Further, the term “photopolymerization” includes a radical polymerization that proceeds under the action of a photopolymerization initiator, which is capable of generating a radical with irradiation of a light; and the term “photopolymerizable group” includes a group capable of being polymerized under the action of a chemical species such as a radical generated as a polymerization initiation point from a photopolymerization initiator with irradiation of a light.

1. Adhesive Composition

The adhesive composition according to the present invention includes a polymerizable group-containing siloxane compound. The adhesive composition according to the present invention further includes a polymerization initiator capable of generating a radical to initiate polymerization and curing of the polymerizable group-containing siloxane compound for bonding of bonding objects and an ultraviolet-absorbing blowing agent capable of, after the bonding, generating a gas and thereby causing blowing in the polymer of the polymerizable group-containing siloxane compound under the action of ultraviolet irradiation so as to release the bonding of the bonding objects.

The respective components of the adhesive composition according to the present invention will be explained below.

1-1. Polymerizable Group-Containing Siloxane Compound

As the polymerizable group-containing siloxane compound, there can suitably be used an alkoxysilane hydrolysis condensate with a photopolymerizable group or cage-like silsesquioxane with a polymerizable group. Each of the alkoxysilane hydrolysis condensate with the photopolymerizable group and the cage-like silsesquioxane with the polymerizable group is high in heat resistance. It is thus possible to impart high heat resistance to the adhesive composition by the use of such a siloxane compound.

The alkoxysilane hydrolysis condensate with the photopolymerizable group is preferably a condensate obtained by hydrolysis-condensation reaction of at least one kind of alkoxysilane of the following general formula (1) and at least one kind of alkoxysilane of the following general formula (2).

(R¹)ₓSi(OR²)₄₋ₓ (1)

In the general formula (1), R¹ each independently represents a methyl group or phenyl group; R² each independently represents a methyl group or ethyl group; and x represents an integer of 0 to 3.

(R³)ₓSi(OR⁴)₄₋ₓ (2)

In the general formula (2), R³ each independently represents a photopolymerizable group; R⁴ each independently represents a methyl group or ethyl group; and x represents an integer of 1 to 3.

As R³, preferred is at least one kind of photopolymerizable group selected from the group consisting of acryloyl group, methacryloyl group and vinyl group.

One example of the alkoxysilane hydrolysis condensate is a compound obtained using, as the alkoxysilane of the general formula (1), phenyltrimethoxysilane (R¹=phenyl group, R²=methyl group, x=1) and dimethylethoxysilane (R¹=methyl group, R²=ethyl group, x=1) and using, as the alkoxysilane of the general formula (2), 3-(trimethoxysilyl)propylmethacrylate (R³=propylmethacrylate group, R⁴=methyl group, x=1). It is assumed that this alkoxysilane hydrolysis condensate has a structural moiety of the following formula. In the following formula, the wavy line means a continuation of the linkage.

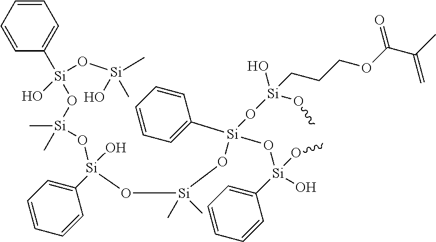

The cage-like silsesquioxane with the polymerizable group is preferably a cage-like silsesquioxane having at least one kind selected from the group consisting of acryloyl group, methacryloyl group and vinyl group as the polymerizable group. The cage-like silsesquioxane with the polymerizable group can be prepared by a conventionally known hydrosilylation reaction process.

One preferred example of the cage-like silsesquioxane with the polymerizable group is a siloxane compound of the following formula.

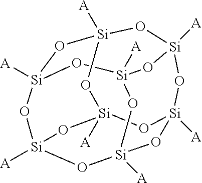

In the above formula, 1 to 8 out of eight R each represent a polymerizable group selected from the group consisting of acryloyl group, methacryloyl group and vinyl group; and the other R each represent a group other than the polymerizable group, i.e., a group inert to the polymerization initiator, which generates a radial by irradiation of a light of e.g. 300 to 900 nm wavelength or by heating e.g. at 60 to 200° C., such as an alkyl or aryl group with no double bond.

1-2. Polymerization Initiator

As the polymerization initiator, there can suitably be used a photo radial polymerization initiator capable of generating a radical under light irradiation or a thermal radical polymerization initiator capable of generating a radial under heating. It is feasible to appropriately select and use either one of the photo radical polymerization initiator and the thermal radical polymerization initiator depending on the kind of the polymerizable group of the polymerizable group-containing siloxane compound. The photo radical polymerization initiator is used in the case where the bonding objects are bonded by the adhesive composition under light irradiation. The thermal radical polymerization initiator is used in the case where the bonding objects are bonded by the adhesive composition under heating.

The photo radial polymerization initiator is preferably of the type capable of generating a radial with irradiation of a light having a wavelength of 300 to 900 nm.

The photo radical polymerization initiator is classified into an intramolecular cleavage type photo radical polymerization initiator that generates a radical upon cleavage of a bond in the molecule by absorption of a high-energy ray and a hydrogen abstraction type photo radical polymerization initiator that generates a radical in combination with a hydrogen source such as tertiary amine or ether. In the present invention, the photo radical polymerization initiator can be of either intramolecular cleavage type or hydrogen abstraction type. As the intramolecular cleavage type photo radical polymerization initiator, there is known 2-hydroxy-2-methyl-1-phenyl-propan-1-one (available under the trade name of Darocur 1173 from Chiba Specialty Chemicals Inc.), which generates a radical upon cleavage of a carbon-carbon bond in the molecule with irradiation of a light (especially, ultraviolet light). As the hydrogen abstraction type photo radical polymerization initiator, there are known benzophenone, methyl o-benzoylbenzoate, 4-benzoyl-4′-methyldiphenylsulfide and camphorquinone, each of which generates a radical by bimolecular reaction with a hydrogen source. Under the action of the thus-generated radical, a double-bond of acryloyl group, methacryloyl group or vinyl group is cleaved and polymerized.

In particular, camphorquinone is preferred as the photo radical polymerization initiator in the adhesive composition according to the present invention in view of the fact that camphorquinone has a light absorption wavelength in the vicinity of 470 nm and is thus inert to an ultraviolet light of 200 to 420 nm wavelength. In the case of using camphorquinone, it is preferable to use an amine compound e.g. 2-(dimethylamino)ethylmethacrylate as a polymerization accelerator in combination with camphorquinone so as to speed up the bonding.

The photo radial polymerization initiator can be used without particular limitation as long as the photo radical polymerization initiator is capable of generating a radical under light absorption.

Examples of the photo radial polymerization initiator are those available from Chiba Specialty Chemicals Inc., including Darocur series such as 2-hydroxy-2-methyl-1-phenyl-propan-1-one (trade name: Darocur 1173) and Drarocur TPO and Irgacure series such as 2-hydroxy-1-{4-[4-(2-hydroxy-2-methylpropionyl)benzyl]phenyl}-2-methyl-propan-1-on (trade name: Irgacure 127), 1-hydroxy-cyclohexyl phenyl ketone (trade name: Irgacure 184), 1-[4-(2-hydroxyethoxy)phenyl]-2-hydroxy-2-methyl-1-propan-1-on (trade name: Irgacure 2959), 2-benzyl-2-dimethylamino-1-(4-morpholinophenyl)-butanone-1 (trade name: Irgacure 369), Irgacure 379, 2-(dimethylamino)-2-[(4-methylphenyl)methyl]-1-[4-(morpholinyl)phenyl]-1-butanone (trade name: Irgacure 379EG), a mixture of oxyphenyl acetic acid, 2-(2-oxo-2-phenylacetoxyethoxy)ethyl ester and 2-(2-hydroxyethoxy)ethyl ester (Irgacure 754), 2-methyl-1-(4-methylthiophenyl)-2-morpholinopropan-1-on (trade name: Irgacure 907), Irgacure 1700, Irgacure 1800, Irgacure 1850, Irgagure 1870, bis(2,4,6-trimethylbenzoyl)phenylphosphine oxide (trade name: Irgacure 819), bis(η5-2,4-cyclopentadiene-1-yl)phenyl titanium (trade name: Irgacure 784) and Irgacure 4265.

A sensitizer may be added to the photo radial polymerization initiator in order to increase the absorption rate of the light of 300 to 900 nm wavelength. For example, it is feasible to accelerate the generation of the radical by adding, as the sensitizer, an organic boron compound available under the trade name of P3B, BP3B, N3B or MN3B from Showa Denko K.K. in combination with a specific sensitizing dye. In this case, a near-ultraviolet-absorbing dye available under the trade name of IR-T or IR13F from Showa Denko K.K is usable as the sensitizing dye. Other sensitizers such as anthracene, 2-ethyl-9,10-dimethoxyanthracene and 2-isopropylthioxanthone are also usable and are commercially available sensitizers under the trade name of KAYACURE DETX-S from Nippon Kayaku Co., Ltd. and under the trade names of IR-T and IR13F from Showa Denko K.K.

The thermal radical polymerization initiator is a compound capable of generating a radial upon cleavage of a bond in the molecule under heating. As the thermal radical polymerization initiator, there can be used an azo compound such as azobisisobutyronitrile (AIBN) and an organic peroxide such as benzoyl peroxide (BPO).

Examples of the azo polymerization initiator are those available from Wako Pure Chemical Industries, Ltd., including water-soluble azo polymerization initiators under the trade names of VA-044, VA-046B, V-50, VA-057, VA-060, V-061, VA-067, VA-080 and VA-086, oil-soluble azo polymerization initiators under the trade names of V-70, V-65, V-601, V59, V-40, VF-096, V-30, VAm-100 and VAm-111 and macro azo polymerization initiators under the trade names of VSP-1001, VSE-0201, VPE-0401 and VPE-0601.

Examples of the organic peroxide polymerization initiators are those available from NOF Corporation, including di-t-butyl peroxide (trade name: Perbutyl D), dicumyl peroxide (trade name: Percumyl D) and dicumyl peroxide (trade name: Percumyl D-40).

Among others, dicumyl peroxide is particularly preferred as the thermal radical polymerization initiator in view of the fact that dicumyl peroxide does not give a by-product gas such as carbon dioxide during radical generation.

1-3. Ultraviolet-Absorbing Blowing Agent

The ultraviolet-absorbing blowing agent is used for gas generation in the adhesive composition according to the present invention. The ultraviolet-absorbing blowing agent is a compound capable of absorbing an ultraviolet light of 200 to 420 nm wavelength and making a chemical change to generate a gas under the action of the ultraviolet light. As such a compound, there can be used an organic compound having a diketone skeleton or a diazonium salt (—N₂⁺).

Examples of the organic diketone compound are anthracene diketone of the following chemical formula (3) and pentacene diketone of the following chemical formula (4). These compounds are known compounds whose synthesis methods are disclosed in Non-Patent Documents 2, 3 and 4.

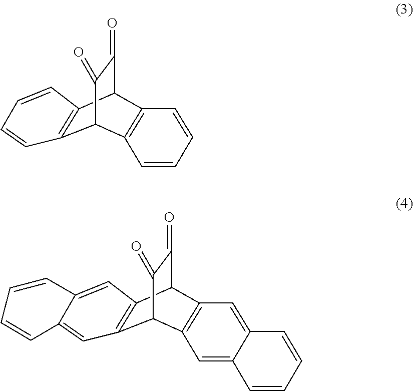 [SMILES: O=C1C(=O)C2c3ccccc3C1c1ccccc12 ; O=C1C(=O)C2c3cc4ccccc4cc3C1c1cc3ccccc3cc12]

Examples of the diazonium salt are 4-diazodiphenylamine sulfate and p-morpholinobenzenediazonium tetrafluoroborate.

1-4. Other Additives

An additive such as a polar group-containing compound may be added to the adhesive composition according to the present invention in order to improve or control adhesion between the substrate and the adhesive composition. For example, it is feasible to secure strong adhesion by adding, as the polar group-containing comound, (2-hydroxyethyl)methacrylate, pentaerythritol triacrylate (available under the trade name of Viscoat #300 from Osaka Organic Chemical Industry Ltd.), epoxy acrylate (available under the trade name of Viscoat #540 from Osaka Organic Chemical Industry Ltd.), tri(2-acryloyloxyethyl)phosphate (available under the trade name of Viscoat 3PA from Osaka Organic Chemical Industry Ltd.), bis(2-acryloyloxyethyl)phosphoric ester (available under the trade name of KAYAMER PM-2 from Nippon Kayaku Co., Ltd.), pentaerythritol tetrakis(3-mercaptobutylate) (available under the trade name of Karenz MTPE1 from Showa Denko K.K.) or the like.

The polar group-containing compound can be added in an amount of 1 to 50 mass % relative to the total mass of three components of the adhesive composition, i.e., the polymerizable group-containing silsesquioxane, the polymerization initiator and the ultraviolet-absorbing blowing agent. If the amount of the polar group-containing compound is less than 1 mass %, the polar group-containing compound may not provide a sufficient adhesion improvement effect. It is not necessary to add the polar group-containing compound in an amount exceeding 50 mass %. If the polar group-containing compound is added in such a large amount, the polar group-containing compound may interfere with the actions of the polymerizable group-containing silsesquioxane, the polymerization initiator and the ultraviolet-absorbing blowing agent.

1-5. Content Ratio of Adhesive Composition

In the adhesive composition according to the present invention, the content ratio of the polymerizable group-containing silsesquioxane, the polymerization initiator and the ultraviolet-absorbing blowing agent is preferably in the range of polymerizable group-containing silsesquioxane:polymerization initiator:ultraviolet-absorbing blowing agent=50 to 98%:0.1 to 10%:1 to 49.9% in terms of mass ratio. If the content ratio is out of this range, there is likely to occur a problem such as weak adhesion, excessive blowing or the like. In the case of adding the additive to the adhesive composition according to the present invention, the amount of the additive added is preferably 1 to 50% relative to the total mass of three components of the adhesive composition except the additive, i.e., the polymerizable group-containing silsesquioxane, the polymerization initiator and the ultraviolet-absorbing blowing agent.

2. Bonding Method

Next, the bonding method using the adhesive composition according to the present invention will be explained below. The following explanation will be specifically be given of the bonding of a silicon substrate and a support substrate for the formation of through holes for TSV in a three-dimensional packaging technology.

The bonding method according to the present invention is to bond substrates by the adhesive composition. In the case of adopting the bonding method for the formation of through holes for TSV in the three-dimensional packaging technology, the substrates to be bonded are preferably a silicon substrate for IC patterning and a glass substrate for supporting, as a support substrate, the silicon substrate during grinding. It is feasible to bond the substrates together by applying the adhesive composition to between the substrates, irradiating the adhesive composition with a light or heating the adhesive composition such that the polymerization initiator makes a chemical change and generates a radical for initiation of polymerization, and thereby polymerizing and curing the adhesive composition. Preferably, an alkoxysilane hydrolysis condensate with a polymerizable group is applied in advance to a bonding surface of the glass substrate in order to increase the adhesion strength between the glass substrate and the adhesive composition.

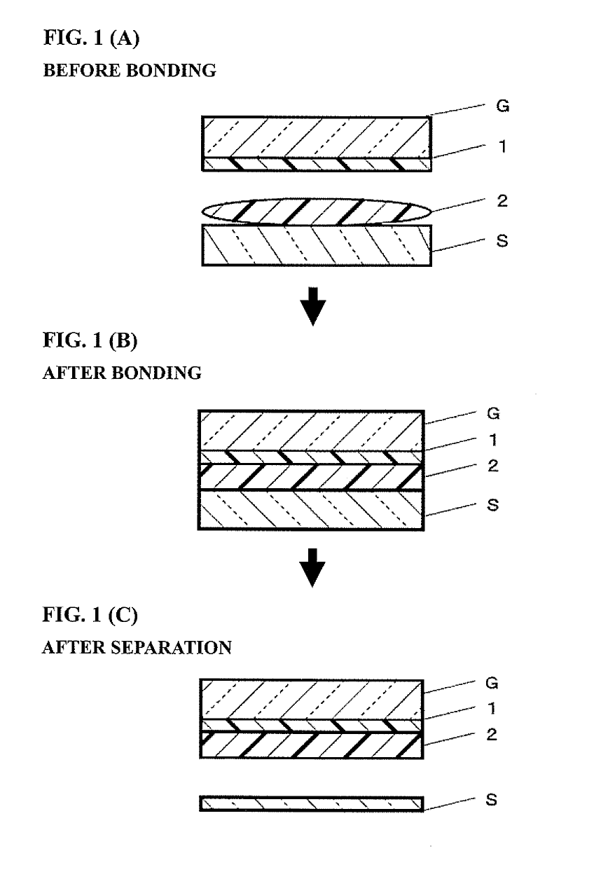

The bonding method using the adhesive composition according to the present invention for three-dimensional packaging of semiconductor chips by TSV will be explained in detail below with reference to FIGS. 1(A), 1(B) and 1(C). It should be however noted that the bonding method using the adhesive composition according to the present invention is not limited to the embodiment of FIGS. 1(A), 1(B) and 1(C).

FIGS. 1(A), 1(B) and 1(C) are schematic views showing steps of bonding and separation of a glass substrate and a silicon substrate.

More specifically, one preferred embodiment of the bonding method using the adhesive composition according to the present invention is for use in the three-dimensional packaging of semiconductor chips by TSV. In this preferred embodiment, a glass substrate G as a support substrate and a silicon substrate S are bonded together by applying the alkoxysilane hydrolysis condensate with the polymerizable group and the adhesive composition according to the present invention as a coating layer 1 and an adhesive composition layer 2 on one surface of the glass substrate G and one substrate of the silicon substrate S as shown in FIG. 1(A), bringing the coating layer 1 on the surface of the glass substrate G into contact with the adhesive composition layer 2 on the surface of the silicon substrate S to which the adhesive composition according to the present invention has been applied as an adhesive composition layer 2 to laminate the glass substrate G and the silicon substrate S to each other as shown in FIG. 1(B), and then, irradiating the adhesive composition layer 2 with a light or heating the adhesive composition layer 2. It is preferable that, in this bonding step, the surfaces of the glass substrate G and the silicon substrate S are clean.

As the alkoxysilane hydrolysis condensate with the polymerizable group, there can be used a condensate obtained by hydrolysis-condensation reaction of at least one kind of alkoxysilane of the following general formula (1) and at least one kind of alkoxysilane of the following general formula (2) in the same manner as mentioned above.

2-1. Support Substrate.

In the three-dimensional packaging of the semiconductor chips by the TSV, a glass substrate or a quartz glass is used as the support substrate and bonded to the silicon substrate S. Examples of the glass material of the glass substrate are those made of soda-lime glass, non-alkali glass, borosilicate glass, aluminosilicate glass, fused silica glass and synthetic silica glass. Among others, it is preferable to use non-alkali glass, fused silica glass or synthetic silica glass in view of the fact that each of these glass materials does not contain an alkali, which can cause erosion of the semiconductor chips, and has a proven track record in semiconductor manufacturing. In view of the cost efficiency, low-cost non-alkali glass is particularly preferred. In the case of using soda-lime glass having an alkali content, it is preferable to form an alkali barrier film on a surface of the glass substrate in advance so as to prevent elution of the alkali content. There is no particular limitation on the alkali barrier film as long as the alkali barrier film has a closely packed structure with no pin hole. The alkali barrier film can be formed by vacuum evaporation process, sputtering process, thermal decomposition film forming process, sol-gel process etc. One preferred example of the alkali barrier film is a silica film formed by firing colloidal silica etc. in view of good adhesion to the glass substrate.

2-2. Prebonding Step (Step of Formation of Coating Layer on Glass Substrate)

It is preferable, in the three-dimensional packaging of the semiconductor chips by the TSV, to form the coating layer 1 on the support substrate e.g. the glass substrate G with the application of a cast liquid in which the alkoxysilane hydrolysis condensate with the polymerizable group is dissolved in an organic solvent in advance of bonding the substrates by the adhesive composition according to the present invention as shown in FIG. 1(A). The coating layer 1 is particularly preferably formed on the surface of the glass substrate by, after the application of the cast liquid, heating the coating layer 1 to thereby remove the organic solvent from the coating layer 1 and cure the hydrolysis condensate.

The polymerizable group of the hydrolysis condensate is preferably of the same or similar kind to that of the adhesive composition layer 2. In the case of using methacryloyl group as the polymerizable group in the adhesive composition 2 for the subsequent bonding of the glass substrate G and the silicon substrate S, it is preferable to use methacryloyl group or acryloyl group as the polymerizable group of the alkoxysilane hydrolysis condensate for the formation of the coating layer 1 on the glass substrate. The use of such same or similar polymerizable groups allows stronger adhesion due to the formation of a chemical bond at the bonding interface between the coating layer 1 of the polymerizable group-containing alkoxysilane hydrolysis condensate applied to the the glass substrate and the adhesive composition layer 2 of the adhesive composition according to the present invention applied to the silicon substrate. The coating layer 1 has a plurality of silanol groups (—SiOH) for very strong adhesion to the glass surface and for chemical bonding to the adhesive composition 2. More specifically, the coating layer 1 attains strong adhesion to the glass substrate by bonding between silanol groups of the glass surface and silanol groups of the polymerizable group-containing alkoxysilane hydrolysis condensate.

For the formation of the coating layer 1, it is preferable to apply the cast liquid to the glass substrate G after performing hydrophilic treatment on the surface of the glass substrate G. There is no particular limitation on the hydrophilic treatment of the glass substrate G. Examples of the hydrophilic treatment are wet grinding of the surface of the glass substrate G with ceria, irradiation of the surface of the glass substrate G with an ultraviolet (UV) light, dry treatment for decomposing organic substance on the surface of the glass substrate G by contact with ozone or oxygen plasma and piranha treatment for cleaning the surface of the glass substrate G with a solution in which concentrated sulfuric acid and 30 mass % hydrogen peroxide are mixed at a mass ratio of 3:1. The hydrophilic treatment of the glass substrate G can be performed by any technique.

There is no particular limitation on the organic solvent used in the cast liquid for the formation of the coating layer 1 on the glass substrate G as long as the hydrolysis condensate can be dissolved in the organic solvent. Examples of the organic solvent are propylene glycol methyl ether acetate (hereinafter sometimes abbreviated as “PGMEA”) and propylene glycol monomethyl ether (hereinafter sometimes abbreviated as “PGME”). There is no particular limitation on the application process of the cast liquid as long as the coating layer 1 can be formed as a thin flat film on the glass substrate G. For example, spin coating process, dip coating process, bar coating process, roll coating process, slit coating process etc. is adoptable as the application process of the cast liquid. There is also no particular limitation on the thickness of the coating layer 1. In the case of forming the coating layer 1 by spin coating, the thickness of the coating layer 1 is preferably 0.5 to 3 μm for ease of coating application.

The polymerization initiator may alternative be added to the cast liquid. In this case, strong adhesion can be expected due to the formation of a chemical bond between the coating layer 1 and the adhesive composition layer 2 over a wider range under light irradiation or heating during the bonding step.

2-3. Bonding Step

As the application method of the adhesive composition according to the present invention for the formation of the adhesive composition layer 2, spin coating process, roll coating process, slit coating process, screen printing process, ink jet process etc. is adoptable. The adhesive composition layer 2 may alternatively be formed by e.g. placing the adhesive composition in a center portion of the silicon substrate S, laminating the silicon substrate S and the glass substrate G together and thereby spreading the adhesive composition throughout between the substrates. For the bonding of the silicon substrate S and the glass substrate G, the adhesive composition layer 2 is applied to between the silicon substrate S and the glass substrate G as shown in FIGS. 1(A), 1(B) and 1(C) and irradiated with a light of e.g. 300 to 900 nm wavelength or heated at e.g. 60 to 200° C.

In the case of bonding the silicon substrate S and the glass substrate G via the adhesive composition layer 2 by irradiation of the light of 300 to 900 nm wavelength, the light can be irradiated from the back surface side of the glass substrate G opposite the adhesive composition layer 2. It is preferable to set the wavelength of the irradiation light in such a manner that the wavelength of the light covers the absorption wavelength of the photo radical polymerization initiator contained in the adhesive composition layer 2 and, if the sensitizer is added to the photo radical polymerization initiator, the absorption wavelength of the sensitizer. For example, the wavelength of the irradiation light is preferably 300 to 420 nm when 2-hydroxy-2-methyl-1-phenyl-propan-1-one (available under the trade name of Darocur 1173 from Chiba Specialty Chemicals Inc.) is used as the photo radical polymerization initiator. As a light source for such light irradiation, there can be used a high-pressure mercury lamp, an ultra-high-pressure mercury lamp, a medium-pressure mercury lamp, a low-pressure mercury lamp, a metal halide lamp, a xenon flash lamp or an ultraviolet light emitting diode (LED). When Darocur 1173 is used as the photo radical polymerization initiator, the sufficient light irradiation time for the bonding is varied depending on the amount of Darocure 1173 used and the thickness of the adhesive composition layer but is generally 10 seconds or more. There is a case where the light absorption wavelength range of Darocure 1173 overlaps the light absorption wavelength range of the ultraviolet-absorbing blowing agent in the adhesive composition according to the present invention. In this case, the ultraviolet-absorbing blowing agent may cause blowing during the bonding step if the light irradiation time is redundantly long. For use of such a photo radical polymerization initiator, the light irradiation time is preferably as short as possible and, more specifically, is preferably 300 seconds or less, more preferably 120 seconds or less, still more preferably 20 seconds.

When camphorquinone is used as the photo radical polymerization initiator, the wavelength of the irradiation light is preferably set to cover the absorption wavelength of camphorquinone, i.e., 470 nm. As a light source for such light irradiation, there can be used a blue LED or a halogen lamp. When camphorquinone is used as the photo radical polymerization initiator, the sufficient light irradiation time for the bonding is varied depending on the amount of camphorquinone used and the thickness of the adhesive composition layer but is generally 10 seconds or more. The camphorquinone is particularly preferred as the photo radical polymerization initiator in view of the fact that the use of the narrow wavelength range light source such as blue LED reduces the possibility of blowing of the ultraviolet-absorbing blowing agent during the bonding step as the wavelength range of the light source differs from the wavelength range of the ultraviolet light by which the ultraviolet-absorbing blowing agent causes blowing. It is however unnecessary that the light irradiation time is redundantly long and, more specifically, is longer than 600 seconds. The light irradiation time is preferably 300 seconds or less.

In the case of bonding the silicon substrate S and the glass substrate G via the adhesive composition layer 2 by heating at 60 to 200° C., the heating can be performed with the use of a hot plate etc. It is preferable to set the heating temperature in view of the decomposition temperature of the thermal radical polymerization temperature contained in the adhesive composition layer 2. For example, the heating temperature is preferably set to 150 to 180° C. when Percumyl D is used as the thermal radical polymerization initiator. If the heating temperature is lower than 60° C., it takes a long time to complete the bonding. If the heating temperature is higher than 200° C., it is difficult to handle the adhesive composition layer 2 due to quick decomposition of the thermal radical polymerization initiator. Further, it is difficult to ensure good bonding of the silicon substrate S and the glass substrate G if the heating temperature is lower than 60° C. or higher than 200° C.

The adhesive composition layer 2 initiates and undergoes polymerization as the polymerization initiator contained in the adhesive composition layer 2 makes a chemical change by the above-mentioned light irradiation or heating operation. Then, the silicon substrate S and the glass substrate G are bonded together by curing of the adhesive composition layer 2.

As explained above, the bonding can be completed in a short time by light irradiation or heating in the bonding method using the adhesive composition according to the present invention. This enables e.g. quick bonding of the silicon substrate S and the glass substrate G as the support substrate in the TSV formation process

3. Separation Method

It is feasible to quickly separate the objects bonded by the adhesive composition according to the present invention, without causing an adhesive residue, with irradiation of an ultraviolet light of 200 to 420 nm wavelength. The separation is done by the action of the ultraviolet-absorbing blowing agent in the adhesive composition.

The separation method according to the present invention is to, when the silicon substrate S and the glass substrate G are bonded together by the adhesive composition according to the present invention, separate the silicon substrate S and the glass substrate G from each other by ultraviolet light irradiation. As mentioned above, the ultraviolet-absorbing blowing agent is contained in the adhesive composition according to the present invention. Thus, the ultraviolet-absorbing blowing agent contained in the adhesive composition layer 2 causes blowing under the action of the ultraviolet light so as to thereby cause separation of the silicon substrate S and the glass substrate G. The wavelength of the ultraviolet light is preferably 200 to 420 nm for ease of handling. As a light source for such light irradiation, there can be used a high-pressure mercury lamp, an ultra-high-pressure mercury lamp, a medium-pressure mercury lamp, a low-pressure mercury lamp, a metal halide lamp, a xenon flash lamp or an ultraviolet light emitting diode (LED). The sufficient light irradiation time for the separation is varied depending on the kind of the ultraviolet-absorbing blowing agent but is generally 30 seconds or more, preferably 120 seconds or more. It is unnecessary that the light irradiation time is longer than 600 seconds. The light irradiation time is preferably 600 seconds or less.

More specifically, when the ultraviolet-absorbing blowing agent contained in the cured adhesive composition layer 2 causes blowing under ultraviolet light irradiation, there occurs peeling between the adhesive composition layer 2 and the silicon substrate S such that the silicon substrate S and the glass substrate G are spontaneously separated from each other as shown in FIG. 1(C). After the separation, no residue of the adhesive composition is visually seen on the silicon substrate S. This is because the adhesion between the glass substrate G and the coating layer 1 and the adhesion between the coating layer 1 and the adhesive composition layer 2 are stronger than the adhesion between the adhesive composition layer 2 and the silicon substrate S. The silicon substrate S has no silanol group or less silanol groups on its surface, whereas the glass substrate G has a plurality of silanol groups on its surface as mentioned above.

The adhesive composition layer 2 may be subjected to ultraviolet light irradiation in the state where the two substrates bonded by the adhesive composition layer 2 is heated on a hot plate etc. It become easier by heating to cause blowing in the adhesive composition layer 2 and thereby facilitate the separation. The heating temperature is preferably 60 to 200° C.

Alternatively, the adhesive composition layer 2 may be subjected to ultraviolet light irradiation in the state where the two substrates bonded by the adhesive composition layer 2 is immersed into a liquid. It becomes easier to facilitate the separation by penetration of the liquid through the separation interface. Examples of the liquid into which the substrates are immersed are, but are not limited to, water, alcohols such as isopropanol and butanol, PGMEA, PGME and butyl acetate. In order to further facilitate the separation, the liquid may be heated, admixed with a surfactant or used in combination with ultrasonic wave.

As mentioned above, the separation occurs selectively at the interface between the adhesive composition layer 2 and the silicon substrate S. No residue of the adhesive composition layer 2 is visually seen on the silicon substrate S after the separation. In the case of using a conventional adhesive for the TSV formation, it is necessary to perform washing operation for removal of adhesive residue. However, the use of the adhesive composition according to the present invention makes it possible to omit or simplify such washing operation as there cannot be seen any adhesive residue on the silicon substrate S.

4. Applications of Adhesive Composition to Stacked Semiconductors

As explained above, the adhesive composition according to the present invention is useful for three-dimensional packaging of semiconductor chips by TSV. The three-dimensional packaging technologies using the adhesive composition according to the present invention for TSV formation is expected for applications to logic semiconductor devices such as next-generation microprocessor, volatile memories such as Dynamic Random Access Memory (DRAM), flash memories, Micro Electro mechanical Systems (MEMS) etc.

### EXAMPLES

The present invention will be described in more detail below by way of the following examples. It is noted that the following examples are illustrative and are not intended to limit the present invention thereto.

### Examples 1-1 to 1-5 and 2-1 to 2-8

In Examples 1-1 to 1-5 and 2-1 to 2-8, adhesive compositions according to the present invention were prepared with different component ratios. A polymerizable group-containing siloxane compound, a polymerization initiator and an ultraviolet-absorbing blowing agent were contained in each of the adhesive compositions of Examples 1-1 to 1-5 and 2-1 to 2-8.

After the preparation, the adhesive compositions of Examples 1-1 to 1-5 and 2-1 to 2-8 were each tested as follows. The adhesive composition was applied to between a silicon substrate S and a non-alkali glass substrate G. The resulting adhesive composition layer 2 was subjected to light irradiation or heating so as to react the polymerization initiator and thereby polymerize the polymerizable group-containing siloxane compound. The silicon substrate S and the non-alkali glass substrate G were bonded together as the adhesive composition layer 2 was cured by polymerization. Subsequently, the adhesive composition layer 2 was irradiated with an ultraviolet light. The silicon substrate S and the non-alkali glass substrate G were separated from each other as the blowing agent caused blowing in the adhesive composition layer 2 under ultraviolet light irradiation. The states of the substrates S and G after the separation were examined for performance evaluation of the adhesive composition.

1. Adhesive Compositions

The component ratios of the adhesive compositions of Examples 1-1 to 1-5 and 2-1 to 2-8 according to the present invention are shown in TABLES 1 and 2.

TABLE 1

| | | | | | Ultraviolet- |
|---|---|---|---|---|---|
| | Polymerizable group-containing | Photopolymerization | | Polymerization | absorbing |
| | siloxane compound | initiator | Curing aid | accelerator | blowing agent |
| Example 1-1 | alkoxysilane hydrolysis condensate | camphorquinone | pentaerythritol | 2-(dimethylamino)ethylmethacrylate | anthracene diketone |
| | with methacryloyl group | (1.8%) | triacrylate | (0.9%) | (10.0%) |
| | (69.3%) | | (18.0%) | | |
| Example 1-2 | alkoxysilane hydrolysis condensate | camphorquinone | pentaerythritol | 2-(dimethylamino)ethylmethacrylate | 4-diazodiphenyl |
| | with methacryloyl group | (1.8%) | triacrylate | (0.9%) | amine sulfate |
| | (69.3%) | | (18.0%) | | (10.0%) |
| Example 1-3 | alkoxysilane hydrolysis condensate | 2-hydroxy-2-methyl- | pentaerythritol | none | anthracene diketone |
| | with methacryloyl group | 1-phenyl-propan-1-one | triacrylate | | (10.0%) |
| | (69.3%) | (2.7%) | (18.0%) | | |
| Example 1-4 | alkoxysilane hydrolysis condensate | 2-hydroxy-2-methyl- | pentaerythritol | none | 4-diazodiphenyl |
| | with methacryloyl group | 1-phenyl-propan-1-one | triacrylate | | amine sulfate |
| | (69.3%) | (2.7%) | (18.0%) | | (10.0%) |
| Example 1-5 | alkoxysilane hydrolysis condensate | camphorquinone | none | 2-(dimethylamino)ethylmethacrylate | anthracene diketone |
| | with methacryloyl group | (2.0%) | | (0.9%) | (10.0%) |
| | (87.0%) | | | | |

The term % inside the parentheses ( ) refers to mass %.

TABLE 2

| | Polymerizable | Photo- | | | |
|---|---|---|---|---|---|
| | group-containing | polymerization | | Polymerization | Ultraviolet-absorbing |
| | siloxane compound | initiator | Curing aid | accelerator | blowing agent |
| Example 2-1 | cage-like silsesquioxane | camphorquinone | pentaerythritol | 2-(dimethylamino)ethylmethacrylate | anthracene diketone |
| | methacrylate | (1.8%) | triacrylate | (0.9%) | (10.0%) |
| | (69.3%) | | (18.0%) | | |
| Example 2-2 | cage-like silsesquioxane | camphorquinone | pentaerythritol | 2-(dimethylamino)ethylmethacrylate | 4-diazodiphenyl |
| | methacrylate | (1.8%) | triacrylate | (0.9%) | amine sulfate |
| | (69.3%) | | (18.0%) | | (10.0%) |
| Example 2-3 | cage-like silsesquioxane | Irgacure 2959 | pentaerythritol | none | anthracene diketone |
| | methacrylate | (2.7%) | triacrylate | | (10.0%) |
| | (69.3%) | | (18.0%) | | |
| Example 2-4 | cage-like silsesquioxane | Irgacure 2959 | pentaerythritol | none | 4-diazodiphenyl |
| | methacrylate | (2.7%) | triacrylate | | amine sulfate |
| | (69.3%) | | (18.0%) | | (10.0%) |
| Example 2-5 | cage-like silsesquioxane | camphorquinone | none | 2-(dimethylamino)ethylmethacrylate | anthracene diketone |
| | methacrylate | (2.0%) | | (1.0%) | (10.0%) |
| | (87.0%) | | | | |
| Example 2-6 | cage-like silsesquioxane | dicumyl peroxide | pentaerythritol | none | anthracene diketone |
| | methacrylate | (0.9%) | triacrylate | | (10.0%) |
| | (71.1%) | | (18.0%) | | |
| Example 2-7 | cage-like silsesquioxane | dicumyl peroxide | pentaerythritol | none | 4-diazodiphenyl |
| | methacrylate | (0.9%) | triacrylate | | amine sulfate |
| | (71.1%) | | (18.0%) | | (10.0%) |
| Example 2-8 | cage-like silsesquioxane | dicumyl peroxide | none | none | anthracene diketone |
| | methacrylate | (1.0%) | | | (10.0%) |
| | (89.0%) | | | | |

The term % inside the parentheses ( ) refers to mass %.

The adhesive compositions of Examples 1-1 to 1-5 were each prepared with the use of an alkoxysilane hydrolysis condensate with a photopolymerizable group as polymerizable group-containing siloxane compound so as to allow bonding by light irradiation. The adhesive compositions of Examples 2-1 to 2-5 were each prepared with the use of a cage-like silsesquioxane with a polymerizable group as polymerizable group-containing siloxane compound so as to allow bonding by light irradiation. Further, the adhesive compositions of Examples 2-6 to 2-8 were each prepared with the use of a cage-like silsesquioxane with a polymerizable group as polymerizable group-containing siloxane compound so as to allow allow bonding by heating.

In Examples 1-1 to 1-5, an alkoxysilane hydrolysis condensate with a methacryloyl group was synthesized and used as the alkoxysilane hydrolysis condensate with the photopolymerizable group.

More specifically, a 2-L flask was equipped with a Dimroth condenser and an impeller and charged with 140.40 g of phenyltrimethoxysilane (available under the trade name of KBM-103 from Shin-Etsu Chemical Co., Ltd.), 131.14 g of dimethyldiethoxysilane (available under the trade name of KBE-22 from Shin-Etsu Chemical Co., Ltd.), 48.56 g of 3-(trimethoxysilyl)propyl methacrylate (available from Tokyo Chemical Industry Co., Ltd.), 213.32 g of isopropyl alcohol, 160.96 g of water and 0.10 g of acetic acid. In the state where the flask was heated to 90° C. in an oil bath, the mixture inside the flask was reacted for 6 hours by stirring at a stirring speed of 200 rpm. The reaction mixture was left still and cooled to room temperature (20° C.). After that, 400 ml of isopropyl ether and 400 ml of water were added to the reaction mixture. The resulting organic phase was then extracted from the reaction mixture by a separatory funnel. The extracted organic phase was dehydrated with magnesium sulfate. Subsequently, the organic solvent was distilled from the dehydrated organic phase by an evaporator. By this, 170.68 g of the alkoxysilane hydrolysis condensate with the photopolymerizable group was obtained as colorless transparent solid matter.

In Examples 2-1 to 2-8, a cage-like silsesquioxane with a methacryloyl group (hereinafter sometimes referred to as “cage-like silsesquioxane methacrylate”) was synthesized and used as the cage-like silsesquioxane with the polymerizable group.

More specifically, the cage-like silsesquioxane with the methacryloyl group (cage-like silsesquioxane methacrylate) was synthesized by the following reaction process.

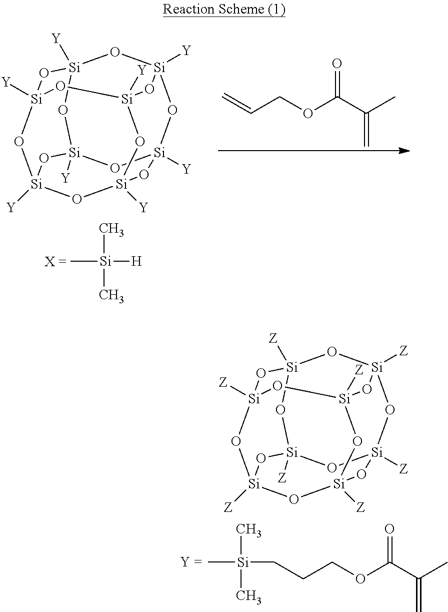

A 200-ml eggplant-shaped flask was charged with 10.26 g of octa(dimethylsilyl)octasilsesquioxane (available under the trade name of SH1310 from U.S. Hybrid Plastics, Inc.), 10.81 g of allyl methacrylate (available from Tokyo Chemical Industry Co., Ltd.), 100 ml of toluene and 30 ml of xylene solution of platinum(0)-1,3-divinyl-1,1,3,3-tetramethyldisiloxane complex as a platinum catalyst (platinum concentration: 2 mass %; available from Aldrich Co., Ltd.). The mixture inside the flask was stirred at room temperature (20° C.) over a night (24 hours). Then, toluene and unreacted allyl methacrylate were removed from the reaction mixture by an evaporator. By this, 17.6 g of the polymerizable cage-like silsesquioxane was obtained as pale yellow liquid matter.

In Examples 1-1, 1-2, 1-5, 2-1, 2-2 and 2-5, camphorquinone having sensitivity to a blue ray of 470 nm wavelength from a blue laser diode (blue LED) was used as a photo radical polymerization initiator. In Examples 1-3 and 1-4, 2-hydroxy-2-methyl-1-phenyl-propan-1-one (available under the trade name of Darocur 1173 from Chiba Specialty Chemicals Inc.) having sensitivity to an ultraviolet ray of 365 nm wavelength from a high-pressure mercury lamp was used as a photo radical polymerization initiator. In Examples 2-3 and 2-4, 1-[4-(2-hydroxyethoxy)phenyl]-2-hydroxy-2-methyl-1-propan-1-on (available under the trade name of Irgacure 2959 from Chiba Specialty Chemicals Inc.) having sensitivity to an ultraviolet ray of 365 nm wavelength from a high-pressure mercury lamp was used as a photo radical polymerization initiator. In Examples 2-6 to 2-8, dicumyl peroxide (available under the trade name of Percumyl D from NOF Corporation) was used as a thermal radial polymerization initiator.

In Examples 1-1 to 1-4, 2-1 to 2-4, 2-6 and 2-7, pentaerythritol triacrylate (available under the trade name of Viscoat #300 from Osaka Organic Chemical Industry Ltd.) was added as a curing aid in order to improve the bonding strength between the silicon substrate S and the non-alkali glass substrate G. In Examples 1-1, 1-2, 2-1, 2-2 and 2-5, 2-(dimethylamino)ethyl methacrylate (available from Tokyo Chemical Industry Co., Ltd.) was added as a polymerization promoter to camphorquinone.

In Examples 1-1, 1-3, 1-5, 2-1, 2-3, 2-5, 2-6 and 2-8, anthracene diketone was used as the ultraviolet-absorbing blowing agent. In Examples 1-2, 1-4, 2-2, 2-4 and 2-7, 4-diazodiphenylamine sulfate (available from Tokyo Chemical Industry Co., Ltd.) was used as the ultraviolet-absorbing blowing agent.

2. Bonding of Silicon Substrate S and Non-Alkali Glass Substrate G

2.1. Formation of Coating Layer

For the bonding of the silicon substrate S and the non-alkali glass substrate G, a coating layer 1 was formed on the non-alkali glass substrate G with the application of an alkoxysilane hydrolysis condensate before the formation of an adhesive composition layer 2 from each of the adhesive compositions of Examples 1-1 to 1-5 and Examples 2-1 to 2-8, as shown in FIG. 1(A), for the purpose of increasing the adhesion strength between the non-alkali glass substrate G and the adhesive composition layer 2.

2-1-1. Preparation of Cast Liquid

The alkoxysilane hydrolysis condensate was synthesized in the same manner as above and dissolved in propylene glycol methyl ether acetate (PGMEA), thereby yielding a cast liquid with a condensate concentration of 33 mass %. A non-alkali glass plate was provided as the glass substrate G. The cast liquid was applied to a surface of the non-alkali glass plate as follows for the formation of the coating layer 1.

2-1-2. Application of Cast Liquid to Non-Alkali Glass Substrate

The non-alkali glass substrate G (product number: 7070, available from Corning Inc.) was 100 mm in diameter and 1.1 mm in thickness. The surface of the non-alkali glass substrate G was subjected to grinding with cerium oxide particles (available from Aldrich Co., Ltd.). The above-prepared cast liquid was spin-coated on the surface of the non-alkali glass substrate G by a spin coater at 1000 rpm for 10 seconds, and then, dried by heating on a hot plate of 200° C. for about 20 minutes. By this, the coating layer 1 was formed on the surface of the non-alkali glass substrate G as shown in FIG. 1(A). The thickness of the coating layer 1 was measured with a stylus profilometer (model: Dektak 8, manufactured by U.S. Veeco Instruments Inc.) and determined to be 0.7 μm.

2.2. Formation of Adhesive Composition Layer

As shown in FIG. 1(A), each of the adhesive compositions of Examples 1-1 to 1-5 and 2-1 to 2-8 was spin-coated in an amount of 0.6 g onto the silicon surface S by a spin coater so as to form the adhesive composition layer 2. Then, the silicon substrate S and the non-alkali glass substrate G were laminated to each other via the adhesive composition layer 2 as shown in FIG. 1(B).

2.3. Bonding

In Examples 1-1 to 1-5 and 2-1 to 2-5 (in which the photo radical polymerization initiator was used as the polymerization initiator in the adhesive composition), the silicon substrate S and the non-alkali glass substrate G were bonded together by irradiating a light onto the adhesive composition layer 2 from the side of the non-alkali glass substrate G and thereby curing the adhesive composition layer 2.

More specifically, in Examples 1-1, 1-2, 1-5, 2-1, 2-2 and 2-5 in which camphorquinone was used as the photo radical polymerization initiator, a blue ray of 470 nm wavelength was irradiated from a blue ray irradiator (available under the trade name of LED470 from Optocode Corporation) onto the adhesive composition layer 2 through the non-alkali glass substrate G for 1 minute so that the silicon substrate S and the non-alkali glass substrate G were bonded together by polymerization and curing of the polymerizable group-containing siloxane compound. In Examples 1-3 and 1-4 in which 2-hydroxy-2-methyl-1-phenyl-propan-1-one (available under the trade name of Darocur 1173 from Chiba Specialty Chemicals Inc.) was used as the polymerization initiator and

Examples 2-3 and 2-4 in which 1-[4-(2-hydroxyethoxy)phenyl]-2-hydroxy-2-methyl-1-propan-1-on (available under the trade name of Irgacure 2959 from Chiba Specialty Chemicals Inc.) was used as the polymerization initiator, an ultraviolet ray of 365 nm wavelength was irradiated from an ultraviolet ray irradiator (available under the trade name of UV LIGHT SOURCE EX250 from HOYA-SCHOTT Co., Ltd.) onto the adhesive composition layer 2 through the non-alkali glass substrate G for 20 seconds so that the silicon substrate S and the non-alkali glass substrate G were bonded together by polymerization and curing of the polymerizable group-containing siloxane compound.

In Examples 2-6 to 2-8 (each of which the thermal radical polymerization initiator was used as the polymerization initiator in the adhesive composition), the silicon substrate S and the non-alkali glass substrate G were bonded together by heating the adhesive composition layer 2 on a hot plate of 170° C. for 30 seconds, causing cleavage of dicumyl peroxide (available under the trade name of Percumyl D from NOF Corporation) as thermal radial polymerization initiator and thereby polymerizing and curing the polymerizable group-containing siloxane compound.

3. Separation of Silicon Substrate S and Non-Alkali Glass Substrate G and States of Silicon Substrate S and Non-Alkali Glass Substrate G after Separation

3.1. Separation of Silicon Substrate S and Non-Alkali Glass Substrate G

To separate the silicon substrate S and the non-alkali glass substrate G that had been bonded by curing of the adhesive composition layer 2 in each of Examples 1-1 to 1-5 and 2-1 to 2-8, an ultraviolet light was irradiated onto the adhesive composition layer 2 for 5 minutes from the side of the non-alkali glass substrate G with the use of an ultraviolet ray irradiator (available under the trade name of UV LIGHT SOURCE EX250 from HOYA-SCHOTT Co., Ltd.). The silicon substrate S and the non-alkali glass substrate G were separated from each other by the blowing action of anthracene diketone used as the ultraviolet-absorbing blowing agent in the adhesive compositions of Examples 1-1, 1-3, 1-5, 2-1, 2-3, 2-5, 2-6 and 2-8 and by the blowing action of 4-diazodiphenylamine sulfate (available from Tokyo Chemical Industry Co., Ltd.) used as the ultraviolet-absorbing blowing agent in the adhesive compositions of Examples 1-2, 1-4, 2-2, 2-4 and 2-7.

In the case of irradiating the adhesive composition layer 2 with a ultraviolet ray of 365 nm wavelength from the ultraviolet ray irradiator (available under the trade name of UV LIGHT SOURCE EX250 from HOYA-SCHOTT Co., Ltd.) in Examples 1-3, 1-4, 2-3 and 2-4, the photo radical polymerization initiator such as 2-hydroxy-2-methyl-1-phenyl-propan-1-one (available under the trade name of Darocur 1173 from Chiba Specialty Chemicals Inc.) or 1-[4-(2-hydroxyethoxy)phenyl]-2-hydroxy-2-methyl-1-propan-1-on (available under the trade name of Irgacure 2959 from Chiba Specialty Chemicals Inc.) was reacted by 20 seconds of irradiation during the curing step so as to cause polymerization of the methacryloyl group-containing alkoxysilane hydrolysis condensate or cage-like silsesquioxane methacrylate and thereby cure the adhesive composition layer 2 for bonding of the silicon substrate S and the non-alkali glass substrate G; and the blowing agent such as anthracene diketone or 4-diazodiphenylamine sulfate (available from Tokyo Chemical Industry Co., Ltd.) caused blowing in the adhesive composition layer 2 by 5 minutes of irradiation during the separation step for separation of the silicon substrate S and the non-alkali glass substrate G.

3.2 States of Silicon Substrate S and Non-Alkali Glass Substrate G after Separation

In each of Examples 1-1 to 1-5 and 2-1 to 2-8, the silicon substrate S and the non-alkali glass substrate G were separated spontaneously. The separation occurred between the silicon substrate S and the adhesive composition layer 2. A residue of the adhesive composition layer 2 was present only on the glass substrate G. Any adhesive residue was not visually seen on the silicon substrate S. This is because the separation occurred selectively between the silicon substrate S and the adhesive composition layer 2.

It has thus been confirmed that the silicon substrate S and the non-alkali glass substrate G, when bonded together with the use of the adhesive composition according to the present invention by light irradiation or heating, can be favorably separated by ultraviolet light irradiation without causing any adhesive residue on the silicon substrate S.

### Comparative Examples 1 to 3

In Comparative Examples 1 to 3, adhesive compositions were prepared with component ratios as shown in TABLE 3 in the same manner as in Examples 1-1 to 1-5 and 2-1 to 2-8. The adhesive compositions of Comparative Examples 1 to 3 were different from those of Examples 1-1 to 1-5 and 2-1 to 2-8 in that no ultraviolet-absorbing blowing agent was used in each of the adhesive compositions of Comparative Examples 1 to 3.

TABLE 3

| | Polymerizable group-containing | Photopolymerization | | Polymerization | Ultraviolet-absorbing |
|---|---|---|---|---|---|
| | siloxane compound | initiator | Curing aid | accelerator | blowing agent |
| Comparative | alkoxysilane hydrolysis condensate | camphorquinone | pentaerythritol | 2-(dimethylamino)ethylmethacrylate | none |
| Example 1 | with methacryloyl group | (2.0%) | triacrylate | (1.0%) | |
| | (77.0%) | | (20.0%) | | |
| Comparative | cage-like silsesquioxane | camphorquinone | pentaerythritol | 2-(dimethylamino)ethylmethacrylate | none |
| Example 2 | methacrylate | (2.0%) | triacrylate | (1.0%) | |
| | (77.0%) | | (20.0%) | | |
| Comparative | cage-like silsesquioxane | dicumyl peroxide | pentaerythritol | none | none |
| Example 3 | methacrylate | (1.0%) | triacrylate | | |
| | (79.0%) | | (20.0%) | | |

The term % inside the parentheses ( ) refers to mass %.
Comparative Examples 1-3: No ultraviolet-absorbing blowing agent was used.

In each of Comparative Examples 1 to 3, a coating layer 1 was formed on a non-alkali glass substrate G by the application of an alkoxysilane hydrolysis condensate as shown in FIG. 1(A) in the same manner as in Examples 1-1 to 1-5 and 2-1 to 2-8. Further, each of the adhesive compositions of Comparative Examples 1 to 3 was spin-coated in an amount of 0.6 g onto a silicon surface S by a spin coater so as to form an adhesive composition layer 2. The silicon substrate S and the non-alkali glass substrate G were then laminated to each other via the adhesive composition layer 2 as shown in FIG. 1(B).

In Comparative Examples 1 and 2 in which camphorquinone was used as the photo radical polymerization initiator in the adhesive composition layer 2, a blue ray of 470 nm wavelength was irradiated from a blue ray irradiator (available under the trade name of LED470 from Optocode Corporation) onto the adhesive composition layer 2 through the non-alkali glass substrate G for 1 minute so that the silicon substrate S and the non-alkali glass substrate G were bonded together by polymerization and curing of the cage-like silsesquioxane methacrylate. In Comparative Example 3 in which dicumyl peroxide (available under the trade name of Percumyl D from NOF Corporation) was used as the thermal radical polymerization initiator in the adhesive composition layer 2, the silicon substrate S and the non-alkali glass substrate G were bonded together by heating the adhesive composition layer 2 on a hot plate of 170° C. for 30 seconds, causing cleavage of as thermal radial polymerization initiator and thereby polymerizing and curing the cage-like silsesquioxane methacrylate.

In Comparative Examples 1 to 3, the silicon substrate S and the non-alkali glass substrate G were firmly bonded together so that it was difficult to separate the silicon substrate S from the non-alkali glass substrate G. It has thus been confirmed that, in the case of adding no ultraviolet-absorbing blowing agent to the adhesive composition, the the blowing action of the blowing agent cannot be utilized for the separation.

### REFERENCE EXAMPLES

(Adhesive Composition Preparation and Bonding)

In Reference Examples 1-1 and 2-1, the same adhesive compositions as those of Examples 1-3 and 2-3 were prepared, respectively. Using these prepared adhesive compositions, silicon substrates S and non-alkali glass substrates G were bonded together in the same manner as in Examples 1-1 to 1-5 and 2-1 to 2-8 except that the ultraviolet ray irradiation time of the bonding step was set to 400 seconds differently from Examples 1-3 and 2-3 (ultraviolet ray irradiation time: 20 seconds). More specifically, each of the adhesive compositions of Reference Examples 1-1 and 2-1 was prepared using Doracure 1173 or Irgacure 2959 as the photo radical polymerization initiator and anthracene diketone as the ultraviolet-absorbing blowing agent and applied to form an adhesive composition layer 2 in the same manner as in Examples 1-3 and 2-3. Then, an ultraviolet ray of 365 nm wavelength was irradiated from an ultraviolet ray irradiator (available under the trade name of UV LIGHT SOURCE EX250 from HOYA-SCHOTT Co., Ltd.) onto the adhesive composition layer 2 through the non-alkali glass substrate G for 400 seconds so that the silicon substrate S and the non-alkali glass substrate G were bonded together by polymerization and curing of the methacryloyl group-containing alkoxysilane hydrolysis condensate or cage-like silsesquioxane methacrylate.

In Reference Examples 1-2, 2-2 and 2-3, silicon substrates S and non-alkali glass substrates G were bonded together by preparing and applying adhesive compositions in the same manner as in Examples 1-1 to 1-5 and 2-1 to 2-8 except that no coating layer 1 was formed on the non-alkali glass substrate G.

In Reference Examples 1-3, 2-4 and 2-5, silicon substrates S and non-alkali glass substrates G were bonded together by preparing and applying adhesive compositions in the same manner as in Examples 1-1 to 1-5 and 2-1 to 2-8 except that the non-alkali glass substrate G was not subjected to grinding.

As shown in TABLES 4 and 5, the same adhesive composition as that of Example 1-1 was used in Reference Examples 1-2 and 1-3; the same adhesive composition as that of Example 2-1 was used in Reference Examples 2-2 and 2-4; and the same adhesive composition as that of Example 2-5 was used in Reference Examples 2-3 and 2-5. More specifically, the silicon substrate S and the non-alkali glass substrate G were bonded together and separated from each other by the following procedure in each of Reference Examples 1-2, 1-3 and 2-2 to 2-5.

In Reference Examples 1-2, 1-3, 2-2 and 2-4 in which camphorquinone was used as the photo radical polymerization initiator in the adhesive composition layer 2, a blue ray of 470 nm wavelength was irradiated from a blue ray irradiator (available under the trade name of LED470 from Optocode Corporation) onto the adhesive composition layer 2 through the non-alkali glass substrate G for 1 minute so that the silicon substrate S and the non-alkali glass substrate G were bonded together by polymerization and curing of the methacryloyl group-containing alkoxysilane hydrolysis condensate or cage-like silsesquioxane methacrylate. In Reference Examples 2-3 and 2-5 in which dicumyl peroxide (available under the trade name of Percumyl D from NOF Corporation) was used as the thermal radical polymerization initiator in the adhesive composition layer 2, the silicon substrate S and the non-alkali glass substrate G were bonded together by heating the adhesive composition layer 2 on a hot plate of 170° C. for 30 seconds, causing cleavage of as thermal radial polymerization initiator and thereby polymerizing and curing the cage-like silsesquioxane methacrylate.

(Separation)

To separate the bonded silicon and non-alkali glass substrates S and G, an ultraviolet ray of 365 nm wavelength was irradiated onto the adhesive composition layer 2 for 5 minutes from the side opposite to the non-alkali glass substrate G with the use of an ultraviolet ray irradiator (available under the trade name of UV LIGHT SOURCE EX250 from HOYA-SCHOTT Co., Ltd.). The silicon substrate S and the non-alkali glass substrate G were separated from each other by blowing of anthracene diketone used as the ultraviolet-absorbing blowing agent in the adhesive composition layer 2.

The component ratios of the adhesive compositions of Reference Examples 1-1 to 1-3 and 2-1 to 2-5 are shown in TABLES 4 and 5.

TABLE 4

| | | | | | Ultraviolet- |
|---|---|---|---|---|---|
| | Polymerizable group-containing | Photopolymerization | | Polymerization | absorbing |
| | siloxane compound | initiator | Curing aid | accelerator | blowing agent |
| Reference | alkoxysilane hydrolysis condensate | 2-hydroxy-2-methyl- | pentaerythritol | none | anthracene diketone |
| Example 1-1 | with methacryloyl group | 1-phenyl-propan-1-one | triacrylate | | (10.0%) |
| | (69.3%) | (2.7%) | (18.0%) | | |
| Reference | alkoxysilane hydrolysis condensate | camphorquinone | pentaerythritol | 2-(dimethylamino)ethylmethacrylate | anthracene diketone |
| Example 1-2 | with methacryloyl group | (1.8%) | triacrylate | (0.9%) | (10.0%) |
| | (69.3%) | | (18.0%) | | |
| Reference | alkoxysilane hydrolysis condensate | camphorquinone | pentaerythritol | 2-(dimethylamino)ethylmethacrylate | anthracene diketone |
| Example 1-3 | with methacryloyl group | (1.8%) | triacrylate | (0.9%) | (10.0%) |
| | (69.3%) | | (18.0%) | | |

The term % inside the parentheses ( ) refers to mass %.
Reference Example 1-1: The light irradiation time of the bonding step was set to 400 seconds.
Reference Example 1-2: No coating layer 1 was formed on the non-alkali glass substrate G.
Reference Example 1-3: No grinding was performed on the non-alkali glass substrate G.

TABLE 5

| | Polymerizable | Photo- | | | |
|---|---|---|---|---|---|
| | group-containing | polymerization | | Polymerization | Ultraviolet-absorbing |
| | siloxane compound | initiator | Curing aid | accelerator | blowing agent |
| Reference | cage-like silsesquioxane | Irgacure 2959 | none | none | anthracene diketone |
| Example 2-1 | methacrylate | (2.7%) | | | (10.0%) |
| | (87.3%) | | | | |
| Reference | cage-like silsesquioxane | camphorquinone | pentaerythritol | 2-(dimethylamino)ethylmethacrylate | anthracene diketone |
| Example 2-2 | methacrylate | (1.8%) | triacrylate | (0.9%) | (10.0%) |
| | (69.3%) | | (18.0%) | | |
| Reference | cage-like silsesquioxane | dicumyl peroxide | pentaerythritol | none | anthracene diketone |
| Example 2-3 | methacrylate | (0.9%) | triacrylate | | (10.0%) |
| | (71.1%) | | (18.0%) | | |
| Reference | cage-like silsesquioxane | camphorquinone | pentaerythritol | 2-(dimethylamino)ethylmethacrylate | anthracene diketone |
| Example 2-4 | methacrylate | (1.8%) | triacrylate | (1.0%) | (10.0%) |
| | (69.3%) | | (18.0%) | | |
| Reference | cage-like silsesquioxane | dicumyl peroxide | pentaerythritol | none | anthracene diketone |
| Example 2-5 | methacrylate | (0.9%) | triacrylate | | (10.0%) |
| | (71.1%) | | (18.0%) | | |

The term % inside the parentheses ( ) refers to mass %.
Reference Example 2-1: The light irradiation time of the bonding step was set to 400 seconds.
Reference Examples 2-2 and 2-3: No coating layer 1 was formed on the non-alkali glass substrate G.
Reference Examples 2-4 and 2-5: No grinding was performed on the non-alkali glass substrate G.

(Evaluation)

In Reference Examples 1-1 and 2-1, anthracene diketone used as the ultraviolet-absorbing blowing agent blew in the adhesive composition layer 2 during the curing step. This is because, while the ultraviolet ray of 365 nm wavelength was irradiated onto the adhesive composition layer 2 for 20 seconds during the curing step in Examples 1-3 and 2-3, the ultraviolet ray irradiation time of the curing step was set to 400 seconds so that the ultraviolet ray was excessively irradiated onto the adhesive composition layer 2.

In Reference Examples 1-2, 2-2 and 2-3, the silicon substrate S and the non-alkali glass substrate G were separated spontaneously. However, slight adhesive residues were visually seen on both of the silicon substrate S and the non-alkali glass substrate G. No adhesive separation was visually seen in the case where the coating layer 1 was applied to the non-alkali glass substrate in advance of the application of the adhesive composition for the bonding/separation of the substrates. It can thus be said that it is preferable in the present invention to form the coating layer 1 in advance.

In Reference Examples 1-3, 2-4 and 2-5, the silicon substrate S and the non-alkali glass substrate G were separated spontaneously. However, slight adhesive residues were visually seen on both of the silicon substrate S and the non-alkali glass substrate G. No adhesive separation was visually seen in the case where the non-alkali glass substrate G was subjected to grinding with ceria in advance of the application of the adhesive composition for the bonding/separation of the substrates. It can thus be said that it is preferable in the present invention to subject the non-alkali glass substrate G to hydrophilic treatment such as grinding with ceria in advance.

### DESCRIPTION OF REFERENCE NUMERALS

G: Glass substrate

S: Silicon substrate

1: Coating layer

2: Adhesive composition layer (Adhesive composition)

1. An adhesive composition comprising:
a polymerizable group-containing siloxane compound;
a polymerization initiator; and
an ultraviolet-absorbing blowing agent.

2. The adhesive composition according to claim 1, wherein the polymerizable group-containing siloxane compound is an alkoxysilane hydrolysis condensate with a photopolymerizable group.

3. The adhesive composition according to claim 2, wherein the photopolymerizable group includes at least one kind selected from the group consisting of acryloyl group, methacryloyl group and vinyl group.

4. The adhesive composition according to claim 2, wherein the polymerization initiator is a photo radical polymerization initiator.

5. The adhesive composition according to claim 1, wherein the polymerizable group-containing siloxane compound is a cage-like silsesquioxane with a polymerizable group.

6. The adhesive composition according to claim 5, wherein the polymerizable group includes at least one kind selected from the group consisting of acryloyl group, methacryloyl group and vinyl group.

7. The adhesive composition according to claim 5, wherein the polymerization initiator is either a photo radical polymerization initiator or a thermal radical polymerization initiator.

8. The adhesive composition according to claim 1, wherein the ultraviolet-absorbing blowing agent is either a diketone compound or a diazonium salt.

9. A method for bonding substrates, comprising:
applying the adhesive composition according to claim 1 to between the substrates; and
curing the adhesive composition.

10. The method for bonding according to claim 9, wherein a silicon substrate and a glass substrate are bonded together as the substrates.

11. The method for bonding according to claim 9, wherein the substrates are bonded to together by irradiating the adhesive composition with a light having a wavelength of 300 to 900 nm for a sufficient time to cure the adhesive composition.

12. The method for bonding according to claim 9, wherein the substrates are bonded together by heating the adhesive composition at 60 to 200° C.

13. The method for bonding according to claim 9, further comprising:
applying an alkoxysilane hydrolysis condensate with a photopolymerizable group to a bonding surface of the glass substrate.

14. A method for separating a glass substrate and a silicon substrate that have been bonded together by the adhesive composition according to claim 1, comprising:
allowing the ultraviolet-absorbing blowing agent to cause blowing by irradiating the adhesive composition with a light having a wavelength of 200 to 420 nm.
